(19) United States
(12) Patent Application Publication
(10) Pub. No.: US 2023/0162383 A1
(43) Pub. Date: May 25, 2023

(54) METHOD OF PROCESSING IMAGE, DEVICE, AND STORAGE MEDIUM

(71) Applicant: Beijing Baidu Netcom Science Technology Co., Ltd., Beijing (CN)

(72) Inventors: Qingyue MENG, Beijing (CN); Xiangwei WANG, Beijing (CN)

(21) Appl. No.: 18/147,527

(22) Filed: Dec. 28, 2022

(30) Foreign Application Priority Data
Mar. 11, 2022 (CN) 202210239492.4

(51) Int. Cl. G06T 7/55; G06T 7/60; G06T 7/70; G06T 7/10

(52) U.S. Cl. CPC G06T 7/55; G06T 7/60; G06T 7/70; G06T 7/10; G06T 2207/20021

(57) ABSTRACT

The present application provides a method of processing an image, a device, and a storage medium. A specific implementation solution includes: performing a depth estimation on a target image to obtain a relative depth map for the target image; obtaining a relative height of an image acquisition device according to a ground portion in the relative depth map; obtaining a relative scale of the relative depth map according to the relative height of the image acquisition device and an absolute height of the image acquisition device; and obtaining an absolute depth map for the target image according to the relative scale and the relative depth map.

### CROSS-REFERENCE TO RELATED APPLICATION(S)

This application claims the priority of Chinese Patent Application No. 202210239492.4, filed on Mar. 11, 2022, the entire contents of which are hereby incorporated by reference.

### TECHNICAL FIELD

The present disclosure relates to a field of artificial intelligence, in particular to fields of computer vision, image processing and 3D vision technologies, and may be applied to autonomous driving, intelligent transportation and other scenarios.

### BACKGROUND

A depth information is very important for an autonomous driving system to perceive and estimate its own pose. With a rapid development of deep neural networks, a monocular depth estimation based on deep learning has been extensively studied. Existing monocular depth estimation solutions are mainly to train a monocular depth estimation network based on data with a depth truth-value or to train a monocular depth estimation network based on a non-supervision scheme.

### SUMMARY

The present disclosure provides a method of processing an image, a device, and a storage medium.

According to an aspect of the present disclosure, a method of processing an image is provided, including: performing a depth estimation on a target image to obtain a relative depth map for the target image; obtaining a relative height of an image acquisition device according to a ground portion in the relative depth map; obtaining a relative scale of the relative depth map according to the relative height of the image acquisition device and an absolute height of the image acquisition device; and obtaining an absolute depth map for the target image according to the relative scale and the relative depth map.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method described in any embodiment of the present disclosure.

According to another aspect of the present disclosure, a non-transitory computer-readable storage medium having computer instructions therein is provided, and the computer instructions are configured to cause a computer to implement the method described in any embodiment of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a first schematic flowchart of a method of processing an image according to an embodiment of the present disclosure;

FIG. 2 shows a second schematic flowchart of a method of processing an image according to an embodiment of the present disclosure;

FIG. 3 shows a third schematic flowchart of a method of processing an image according to an embodiment of the present disclosure;

FIG. 4 shows a fourth schematic flowchart of a method of processing an image according to an embodiment of the present disclosure;

FIG. 5 shows a first schematic diagram of an apparatus of processing an image according to an embodiment of the present disclosure;

FIG. 6 shows a second schematic diagram of an apparatus of processing an image according to an embodiment of the present disclosure;

FIG. 7 shows a third schematic diagram of an apparatus of processing an image according to an embodiment of the present disclosure;

FIG. 8 shows a block diagram of an electronic device for implementing a method of processing an image of an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following descriptions.

Existing deep learning solutions for a monocular depth estimation mainly include the following solutions.

In solution 1), a monocular depth estimation network is trained based on a large amount of data with depth truth-values.

In solution 2), a monocular absolute depth estimation network is trained based on a non-supervision solution.

In solution 3), network is trained based on a large amount of public data/self-collected data, so as to obtain a relative depth.

In the above-mentioned deep learning solutions, a data supervision is adopted in solution 1) completely, so that an absolute depth may be obtained accurately. However, solution 1) relies on a large amount of data truth-values, which causes a high cost.

In solution 2), a non-supervision training solution is adopted, so that data may be obtained easily. However, the obtained absolute depth has a low accuracy, which is not conducive to a subsequent use.

In solution 3), since a large amount of data comes from self-collected data, it is possible to obtain a depth with a high accuracy, but an absolute depth may not be obtained.

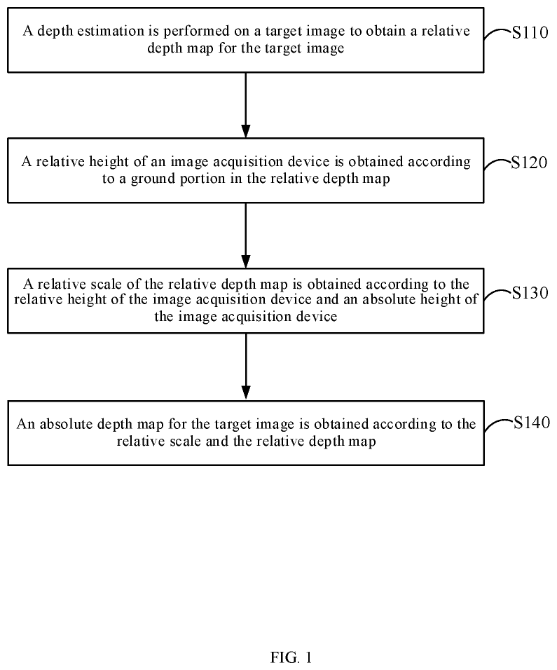

In view of this, the present disclosure proposes a method of processing an image. FIG. 1 shows a schematic flowchart of a method of processing an image according to an embodiment of the present disclosure, which includes the following steps.

In S110, a depth estimation is performed on a target image to obtain a relative depth map for the target image.

In S120, a relative height of an image acquisition device is obtained according to a ground portion in the relative depth map.

In S130, a relative scale of the relative depth map is obtained according to the relative height of the image acquisition device and an absolute height of the image acquisition device.

In S140, an absolute depth map for the target image is obtained according to the relative scale and the relative depth map.

Exemplarily, in step S110, the target image may be input into a trained relative depth estimation network to obtain the relative depth map for the target image. The relative depth map may reflect a distance relationship between pixels.

It may be understood that after the relative height of the image acquisition device in the relative depth map is obtained from the relative depth map, the relative scale of the relative depth map may be obtained according to the absolute height and the relative height of the image acquisition device. The relative scale indicates a proportional relationship between a relative depth in the relative depth map and an actual absolute depth. The absolute depth map for the target image may be obtained by converting the relative depth of each pixel point in the relative depth map into an absolute depth according to the relative scale of the relative depth map. Since the absolute height of the image acquisition device is a fixed value and may be acquired by a simple manual method, the data acquisition method relied on in the above steps is efficient.

With the method of the above embodiments, the relative depth of the relative depth map for the target image may be obtained according to the relative height of the image acquisition device in the relative depth map for the target image and the absolute height of the actual image acquisition device, and then the absolute depth map for the target image may be obtained. A monocular absolute depth estimation network trained by using a large amount of data is not required, and it is not needed to rely on a large amount of data truth-values. It is only required to obtain a relative monocular scale of the target image and the height of the image acquisition device, and then an accurate absolute depth of the target image may be obtained by a small amount of calculation.

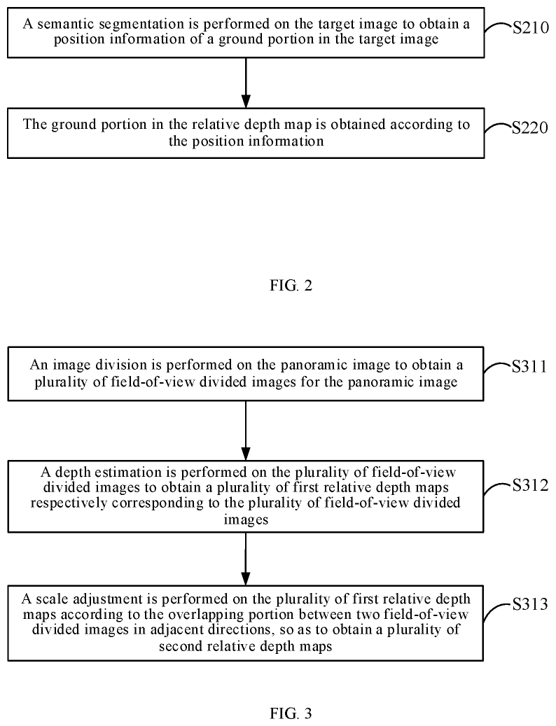

Optionally, as shown in FIG. 2, the method of processing the image in the above embodiments further includes the following steps.

In S210, a semantic segmentation is performed on the target image to obtain a position information of a ground portion in the target image.

In S220, the ground portion in the relative depth map is obtained according to the position information.

Exemplarily, by performing the semantic segmentation on the target image, it is possible to obtain the position information of the ground portion in the target image, that is, the position information of the ground portion in the relative depth map. The ground portion in the relative depth map may be obtained according to the position information of the ground portion in the relative depth map.

It may be understood that after the ground portion in the relative depth map is obtained, the relative height of the image acquisition device in the relative depth map may be obtained by calculating a relative depth difference between a pixel point of the ground portion in the relative depth map and an origin in the relative depth map, which then facilitates a subsequent acquisition of the relative scale of the relative depth map by comparing the relative height of the image acquisition device in the relative depth map with the absolute height of the image acquisition device.

Optionally, the target image may include a panoramic image, and the method of processing the image in the above embodiments is also applicable to the processing of the panoramic image. As shown in FIG. 3, the above step S110 includes the following steps.

In S311, an image division is performed on the panoramic image to obtain a plurality of field-of-view divided images for the panoramic image.

In S312, a depth estimation is performed on the plurality of field-of-view divided images to obtain a plurality of first relative depth maps respectively corresponding to the plurality of field-of-view divided images.

In a case that the relative depth estimation network fails to process the panoramic image directly, according to embodiments of the present disclosure, an image division may be performed on the panoramic image to obtain a plurality of field-of-view divided images for the panoramic image before the relative depth map for the panoramic image is obtained. A depth estimation may be performed on the plurality of field-of-view divided images by using a relative depth estimation network, so as to obtain a plurality of first relative depth maps respectively corresponding to the plurality of field-of-view divided images. In some application scenarios, the plurality of first relative depth maps respectively corresponding to the plurality of field-of-view divided images may be regarded as a relative depth map for the panoramic image.

In the method of the above embodiments, when performing a depth estimation on a panoramic image, an image division is firstly performed on the panoramic image. A feature of the panoramic image may be represented using a plurality of divided images of different fields of view, and then the plurality of field-of-view divided images may be processed by the relative depth estimation network, so that a complexity requirement for the relative depth estimation network may be reduced, and a cost of training the relative depth estimation network may be reduced.

Exemplarily, in the above-mentioned embodiments, the plurality of field-of-view divided images obtained by performing the image division on the panoramic image may cover each pixel point in the panoramic image, and two field-of-view divided images in adjacent directions have an overlapping portion. As shown in FIG. 3, the above step S110 further includes the following steps.

In S313, a scale adjustment is performed on the plurality of first relative depth maps according to the overlapping portion between two field-of-view divided images in adjacent directions, so as to obtain a plurality of second relative depth maps.

It may be understood that a process of performing an image division on the panoramic image is actually to divide the panoramic image through different field-of-view directions to obtain a plurality of ordinary images, that is, the plurality of field-of-view divided images. Since the plurality of field-of-view divided images cover each pixel point in the panoramic image, the plurality of relative depth maps corresponding to the plurality of field-of-view divided images may completely indicate the relative depth of the panoramic image, and then subsequently obtained absolute depth maps corresponding to the plurality of field-of-view divided images may further indicate the absolute depth of the panoramic image.

For the first relative depth maps corresponding to the field-of-view divided images in adjacent directions, the two first relative depth maps may be respectively mapped to a three-dimensional coordinate system where the image acquisition device is located. Since the two field-of-view divided images in adjacent directions have an overlapping portion, the two first relative depth maps necessarily have overlapping pixel points after being mapped to the three-dimensional coordinate system where the image acquisition device is located. A proportional relationship of relative depths in the two first relative depth maps may be obtained according to respective relative depths of the overlapping pixel points in the two first relative depth maps. For all the first depth maps, the proportional relationship between the relative depth of a first depth map and the relative depth of an adjacent first depth map may be obtained. Finally, the relative depths in all the first depth maps may be divided into a same scale according to the proportional relationship, and then a scale adjustment is performed on the obtained plurality of first relative depth maps based on the scale to obtain the plurality of second relative depth maps, so that the relative depths in the plurality of second relative depth maps are at the same scale. In some application scenarios, the plurality of second relative depth maps respectively corresponding to the plurality of field-of-view divided images may be regarded as the relative depth map for the panoramic image.

With the method of the above embodiments, when performing an image division on the panoramic image, the obtained plurality of field-of-view divided images cover each pixel point in the panoramic image, which ensures that the plurality of absolute depth maps respectively corresponding to the plurality of field-of-view divided images obtained by subsequent image processing may completely indicate the absolute depth of the panoramic image. Furthermore, two field-of-view divided images in adjacent directions have an overlapping portion, and the plurality of first relative depth maps corresponding to the plurality of field-of-view divided images may be divided into the same scale by using the overlapping portion, so as to obtain a plurality of second relative depth maps, which is convenient for a subsequent unification of standards to compare with the actual height of the image acquisition device.

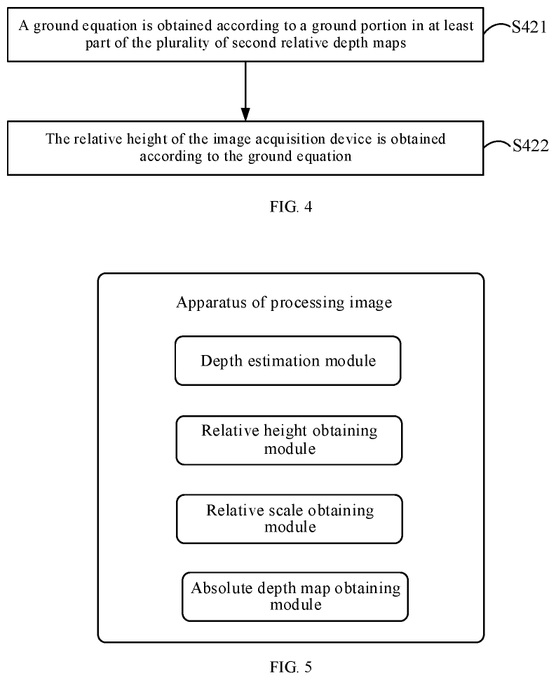

Exemplarily, based on the method of processing the image for the panoramic image in the above embodiments, as shown in FIG. 4, the above step S120 may include the following steps.

In S421, a ground equation is obtained according to a ground portion in at least part of the plurality of second relative depth maps.

In S422, the relative height of the image acquisition device is obtained according to the ground equation.

It may be understood that, in the plurality of field-of-view divided images obtained by dividing the panoramic image, a particular field-of-view divided image may not contain the ground portion. Therefore, it is possible to acquire the pixel point of the ground portion and the origin according to a part of the second relative depth maps corresponding to the field-of-view divided images containing the ground portion. The ground equation may be obtained according to a relative depth information corresponding to the pixel point of the ground portion and the origin.

The ground equation is expressed as: xcosα+ycosβ+zcosγ=p where x, y and z represent the relative depth information of the pixel points of the ground portion, cosα, cosβ and cosγ are direction cosines of a normal vector of a plane, and p is a relative depth difference between the origin and the plane, indicating a distance from the origin to the plane, that is, the relative height of the image acquisition device in the second relative depth map.

In view of a fact that there may be an error between the relative heights obtained from the plurality of second relative depth maps, an average value of a plurality of relative heights may be used as the relative height of the image acquisition device.

With the method of the above embodiments, the relative height of the image acquisition device may be obtained through the plane equation using the second relative depth map containing the ground portion in the plurality of relative depth maps, and an influence of the error may be reduced through an average value calculation, so that the accuracy of the subsequently obtained absolute depth of the panoramic image may be improved.

An image processing of a panoramic image is illustrated below by way of example in specifically describing a specific flow of the above method of processing the image applied to the processing of the panoramic image.

1) An image division is performed on a panoramic image as a target image, so as to obtain a plurality of field-of-view divided images of different fields of view. In a process of the image division, it is required to ensure that the field-of-view divided images of adjacent fields of view have an overlapping portion, and the obtained plurality of field-of-view divided images of different fields of view need to cover all the pixel points of the target panoramic image.

2) A semantic segmentation is performed on the plurality of field-of-view divided images to obtain a position information of a ground portion in a field-of-view divided image containing the ground portion.

3) A plurality of first relative depth maps corresponding to the plurality of field-of-view divided images are obtained by using a trained relative depth estimation network, and two first relative depth maps corresponding to two field-of-view divided images of adjacent fields of view are mapped to a three-dimensional coordinate system of the image acquisition device to compare relative depths of pixel points in the overlapping portion, finally the relative depths in the plurality of first relative depth maps are divided into a same scale, and an adjustment is performed to obtain a plurality of second relative depth maps corresponding to the plurality of first relative depth maps.

4) The ground portion in a part of the second relative depth maps corresponding to the field-of-view divided images containing the ground portion in the plurality of second relative depth maps is obtained according to the position information of the ground portion in field-of-view divided images containing the ground portion, then a plurality of relative heights of the image acquisition device in the second relative depth maps are obtained according to a ground equation, and an average value of the plurality of relative heights is calculated as the relative height of the image acquisition device in the panoramic image.

5) A relative scale of a relative depth and an absolute depth in the plurality of second relative depth maps is obtained according to the relative height of the image acquisition device in the target panoramic image and an actual height of the image acquisition device, and then the plurality of second relative depths are adjusted based on the relative scale to obtain a plurality of second absolute depth maps. Since the field-of-view divided images corresponding to the plurality of second absolute depth maps cover all the pixel points of the target panoramic image, an absolute depth map for the target panoramic image may be obtained according to the plurality of second absolute depth maps.

Further, the image acquisition device in the above embodiments may be an vehicle-mounted camera of an autonomous vehicle or a wide-angle camera for road traffic monitoring, etc., which is not limited here. When the target panoramic image to be processed is a panoramic image captured by an vehicle-mounted camera of an unmanned vehicle or an autonomous vehicle, the target panoramic image may be processed by an autonomous driving system as follows.

1) The panoramic image is divided based on six directions including up, down, left, right, front and back. The field-of-view divided images in four directions of front, back, left and right may be obtained by dividing the panoramic image clockwise or anticlockwise with a 30° field-of-view overlap between two, and the field-of-view divided images in two directions of up and down have a 30° field-of-view overlap with each of the field-of-view divided images in the four directions of front, back, left and right.

2) A semantic segmentation is performed on the field-of-view divided images in the four directions of front, back, left and right, so as to obtain the position information of the ground portion in the four field-of-view divided images respectively.

3) The six field-of-view divided images are processed by the depth estimation network to obtain the first relative depth maps in the six directions. For the first relative depth maps in the four directions of front, back, left and right, the proportional relationship is obtained according to the overlapping portions between two. For the field-of-view divided images in the two directions of up and down, since the two first relative depth maps have overlapping portions with each of the first relative depth maps in the four directions of front, back, left and right, the proportional relationships with each of the first relative depth maps in the four directions of front, back, left and right are obtained respectively, and an average value is determined as a final proportional relationship between the first relative depth maps in the two directions of up and down and the other first relative depth maps. Then an adjustment is performed according to the proportional relationship to obtain the second relative depth maps in the six directions of up, down, left, right, front and back.

4) The ground portion in the second relative depth maps in the four directions of front, back, left and right is obtained according to the position information of the ground portion in the field-of-view divided images in the four directions of front, back, left and right. The relative heights of the vehicle-mounted camera in the four second relative depth maps are obtained based on the ground equation. An average value of the four relative heights is determined as a final relative height of the vehicle-mounted camera in the four second relative depth maps.

5) Relative scales between relative depths in the second relative depth maps in the six directions of up, down, left, right, front and back and the absolute depths are obtained according to the final relative height and the actual height of the vehicle-mounted camera. Then, the second relative depth maps in the six directions are adjusted to obtain absolute depth maps in the six directions of up, down, left, right, front and back. The absolute depth maps in the six directions of up, down, left, right, front and back may reflect the absolute depth of each pixel point in the target panoramic image, which is convenient for the autonomous driving system to perceive and estimate its own pose.

The specific configuration and implementation of embodiments of the present application are described above from different perspectives. With the method provided by the above embodiments, it is possible to obtain an accurate absolute depth of the target image through a small amount of calculation when only the relative monocular scale of the target image and the height of the image acquisition device may be obtained, which may not rely on a large amount of data truth-values. In addition, the method may be used for a monocular absolute depth estimation of a panoramic image to quickly and efficiently obtain the absolute depth of the target image.

FIG. 5 shows a schematic diagram of an apparatus of processing an image according to an embodiment of the present application. The apparatus may include: a depth estimation module 510 used to perform a depth estimation on a target image to obtain a relative depth map for the target image; a relative height obtaining module 520 used to obtain a relative height of an image acquisition device according to a ground portion in the relative depth map; a relative scale obtaining module 530 used to obtain a relative scale of the relative depth map according to the relative height of the image acquisition device and an absolute height of the image acquisition device; and an absolute depth map obtaining module 540 used to obtain an absolute depth map for the target image according to the relative scale and the relative depth map.

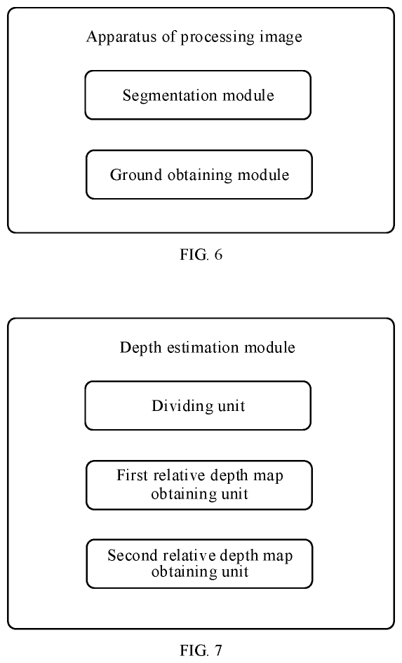

Exemplarity, as shown in FIG. 6, the apparatus further includes: a segmentation module 610 used to perform a semantic segmentation on the target image to obtain a position information of a ground portion in the target image; and a ground obtaining module 620 used to obtain the ground portion in the relative depth map according to the position information.

Optionally, the target image processed by the apparatus of processing the image may include a panoramic image. As shown in FIG. 7, the depth estimation module 510 includes: a dividing unit 711 used to perform an image division on the panoramic image to obtain a plurality of field-of-view divided images for the panoramic image; and a first relative depth map obtaining unit 712 used to perform a depth estimation on the plurality of field-of-view divided images to obtain a plurality of first relative depth maps respectively corresponding to the plurality of field-of-view divided images.

Exemplarily, the plurality of field-of-view divided images obtained by the apparatus of processing the image may cover each pixel point in the panoramic image, and two field-of-view divided images in adjacent directions have an overlapping portion.

As shown in FIG. 7, the depth estimation module 511 further includes: a second relative depth map obtaining unit 713 used to perform a scale adjustment on the plurality of first relative depth maps according to the overlapping portion between two field-of-view divided images in adjacent directions, so as to obtain a plurality of second relative depth maps.

Optionally, the relative height obtaining module 520 is further used to: obtain a ground equation according to a ground portion in at least part of the plurality of second relative depth maps; and obtain the relative height of the image acquisition device according to the ground equation.

Functions of each unit, module or sub-module in each apparatus of embodiments of the present disclosure may be referred to corresponding descriptions in the above embodiments of methods, and have corresponding beneficial effects, which will not be repeated here

In the technical solutions of the present disclosure, an acquisition, a storage and an application of user personal information involved comply with provisions of relevant laws and regulations, and do not violate public order and good custom.

According to embodiments of the present disclosure, the present disclosure further provides an electronic device, a readable storage medium, and a computer program product.

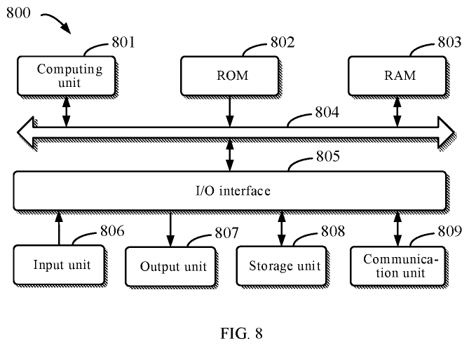

FIG. 8 shows a schematic block diagram of an example electronic device 800 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and steps described above, such as the method of processing the image. For example, in some embodiments, the method of processing the image may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the method of processing the image described above. Alternatively, in other embodiments, the computing unit 801 may be used to perform the method of processing the image by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an image, comprising:
performing a depth estimation on a target image to obtain a relative depth map for the target image;
obtaining a relative height of an image acquisition device according to a ground portion in the relative depth map;
obtaining a relative scale of the relative depth map according to the relative height of the image acquisition device and an absolute height of the image acquisition device; and
obtaining an absolute depth map for the target image according to the relative scale and the relative depth map.

2. The method according to claim 1, further comprising:
performing a semantic segmentation on the target image to obtain a position information of a ground portion in the target image; and
obtaining the ground portion in the relative depth map according to the position information.

3. The method according to claim 1, wherein the target image comprises a panoramic image, and the performing a depth estimation on a target image to obtain a relative depth map for the target image comprises:
performing an image division on the panoramic image to obtain a plurality of field-of-view divided images for the panoramic image; and
performing a depth estimation on the plurality of field-of-view divided images to obtain a plurality of first relative depth maps respectively corresponding to the plurality of field-of-view divided images.

4. The method according to claim 3, wherein the plurality of field-of-view divided images cover each pixel point in the panoramic image, and two field-of-view divided images in adjacent directions have an overlapping portion;
the performing a depth estimation on a target image to obtain a relative depth map for the target image further comprises:
performing a scale adjustment on the plurality of first relative depth maps according to the overlapping portion between two field-of-view divided images in adjacent directions, so as to obtain a plurality of second relative depth maps.

5. The method according to claim 4, wherein the obtaining a relative height of an image acquisition device according to a ground portion in the relative depth map comprises:
obtaining a ground equation according to a ground portion in at least part of the plurality of second relative depth maps; and
obtaining the relative height of the image acquisition device according to the ground equation.

6. An electronic device, comprising:
at least one processor; and
a memory communicatively connected to the at least one processor, wherein the memory stores instructions executable by the at least one processor, and the instructions, when executed by the at least one processor, cause the at least one processor to implement a method of processing an image, comprising operations of:
performing a depth estimation on a target image to obtain a relative depth map for the target image;
obtaining a relative height of an image acquisition device according to a ground portion in the relative depth map;
obtaining a relative scale of the relative depth map according to the relative height of the image acquisition device and an absolute height of the image acquisition device; and
obtaining an absolute depth map for the target image according to the relative scale and the relative depth map.

7. The electronic device according to claim 6, wherein the instructions, when executed by the processor, cause the processor to implement operations of:
performing a semantic segmentation on the target image to obtain a position information of a ground portion in the target image; and
obtaining the ground portion in the relative depth map according to the position information.

8. The electronic device according to claim 6, wherein the target image comprises a panoramic image, and wherein the instructions, when executed by the processor, cause the processor to implement operations of:
performing an image division on the panoramic image to obtain a plurality of field-of-view divided images for the panoramic image; and
performing a depth estimation on the plurality of field-of-view divided images to obtain a plurality of first relative depth maps respectively corresponding to the plurality of field-of-view divided images.

9. The electronic device according to claim 8, wherein the plurality of field-of-view divided images cover each pixel point in the panoramic image, and two field-of-view divided images in adjacent directions have an overlapping portion;
wherein the instructions, when executed by the processor, cause the processor to implement operations of:
performing a scale adjustment on the plurality of first relative depth maps according to the overlapping portion between two field-of-view divided images in adjacent directions, so as to obtain a plurality of second relative depth maps.

10. The electronic device according to claim 9, wherein the instructions, when executed by the processor, cause the processor to implement operations of:
obtaining a ground equation according to a ground portion in at least part of the plurality of second relative depth maps; and
obtaining the relative height of the image acquisition device according to the ground equation.

11. A non-transitory computer-readable storage medium having computer instructions therein, wherein the computer instructions are configured to cause a computer to implement a method of processing an image, comprising operations of:
performing a depth estimation on a target image to obtain a relative depth map for the target image;
obtaining a relative height of an image acquisition device according to a ground portion in the relative depth map;
obtaining a relative scale of the relative depth map according to the relative height of the image acquisition device and an absolute height of the image acquisition device; and
obtaining an absolute depth map for the target image according to the relative scale and the relative depth map.

12. The storage medium according to claim 11, wherein the computer instructions are configured to cause the computer further to implement operations of:
performing a semantic segmentation on the target image to obtain a position information of a ground portion in the target image; and
obtaining the ground portion in the relative depth map according to the position information.

13. The storage medium according to claim 11, wherein the target image comprises a panoramic image, and wherein the computer instructions are configured to cause the computer further to implement operations of:
performing an image division on the panoramic image to obtain a plurality of field-of-view divided images for the panoramic image; and
performing a depth estimation on the plurality of field-of-view divided images to obtain a plurality of first relative depth maps respectively corresponding to the plurality of field-of-view divided images.

14. The storage medium according to claim 13, wherein the plurality of field-of-view divided images cover each pixel point in the panoramic image, and two field-of-view divided images in adjacent directions have an overlapping portion;
wherein the computer instructions are configured to cause the computer further to implement operations of:
performing a scale adjustment on the plurality of first relative depth maps according to the overlapping portion between two field-of-view divided images in adjacent directions, so as to obtain a plurality of second relative depth maps.

15. The storage medium according to claim 14, wherein the computer instructions are configured to cause the computer further to implement operations of:
obtaining a ground equation according to a ground portion in at least part of the plurality of second relative depth maps; and
obtaining the relative height of the image acquisition device according to the ground equation.
